(19) United States
(12) Patent Application Publication
(10) Pub. No.: US 2001/0048558 A1
(43) Pub. Date: Dec. 6, 2001

(54) Reflecting projection unit for a projector

(75) Inventor: Rung-De Lin, Yunlin Hsien (TW)

Correspondence Address: Richard P. Berg, Esq., c/o LADAS & PARRY, Suite 2100, 5670 Wilshire Boulevard, Los Angeles, CA, 90036-5679, US

(73) Assignee: Acer Communications and Multimedia, Inc.

(21) Appl. No.: 09/850,379

(22) Filed: May 7, 2001

(30) Foreign Application Priority Data
May 24, 2000 (TW) 89110009

(51) Int. Cl. G02B 27/64

(52) U.S. Cl. 359/555; 359/556

(57) ABSTRACT

A projector having a projection system includes a reflecting projection unit. The projection system has an image display device and a projection lens, which is provided with an optical axis. The reflecting projection unit includes a first mirror and a second mirror. The first mirror reflects an image from the projection lens according to a predetermined angle. The second mirror receives the image from the first mirror, and reflects it onto a screen. The invention has the advantages of increasing image offset and the zoom ratio of the projector.

### BACKGROUND OF THE INVENTION

1. Field of the Invention

The invention relates to a reflecting projection unit for a projector, and more particularly to a projector having a projection lens, wherein the reflecting projection unit is attached to the projection lens. Therefore, the reflecting projection unit increases the zoom ratio of the projection lens and the image offset.

2. Description of the Related Art

The projector generally use one projection lens to magnify the projecting image and increase the image offset. FIG. 1 shows a projector having a projection lens in the prior art. As shown in FIG. 1, the projector includes an image display device 10, such as transmitting liquid crystal light valve, reflecting liquid crystal light valve and digital micromirror device etc.; and a projection lens 20 having a first lens 22, a second lens 24 and a third lens 26, wherein the first lens 22, the second lens 24 and the third lens 26 form an optical axis (OA) and the projecting image is enlarged or shrank by altering at least one lens position.

However, once the specification of the projection lens, such as the zoom ratio, is predetermined, the maximum area or the minimum area of the projecting image is also predetermined on condition that the distance between the projector and the screen is fixed. As shown in FIG. 2A, as the distance between the projector PJT and the screen SC increases, such as D1 increasing to D2, D2 increasing to D3 etc., or alter the zoom ratio by designing a new projection lens, the area of the projecting image is enlarged.

Moreover, the specification of the image offset is also predetermined. When the height of the projecting image need to be raised, user can increase the projector elevation from the bearing platform or re-design a new projection lens. As shown in FIG. 2B, a distortion image shown on the screen when the angle θ of elevation between the projector and the bearing platform is increased.

### SUMMARY OF THE INVENTION

To solve the above problems, it is an object of the present invention to provide a reflecting projection unit for a projector having a image display device and a projection lens, including a first mirror and a second mirror, wherein the projection lens of the projector has an optical axis (OA) to project images. The first mirror is positioned on the OA to form an included angle with the normal of the first mirror and the OA, and reflects an image from the projection lens. The second mirror is opposite to the first mirror, and reflects the image from the first mirror to the screen.

There are some different combinations between the first and second mirrors, such as the first mirror is a first convex mirror and the second mirror is a second convex mirror, or the first mirror is a first concave mirror and the second mirror is a second convex mirror. In the invention, the convex mirror may be a spherical or aspherical convex mirror, and the concave mirror may be a spherical or aspherical concave mirror.

The invention has an advantage of increasing the zoom ratio of the projector by attaching the reflecting projection unit to the projection lens.

The invention has another advantage of increasing the image offset and preventing the projecting image from distortion by attaching the reflecting projection unit to the projection lens.

### BRIEF DESCRIPTION OF THE DRAWINGS

This and other objects and features of the invention will become clear from the following description, taken in conjunction with the preferred embodiments with reference to the drawings, in which:

FIG. 1 is a schematic view showing a conventional projector having a projection lens;

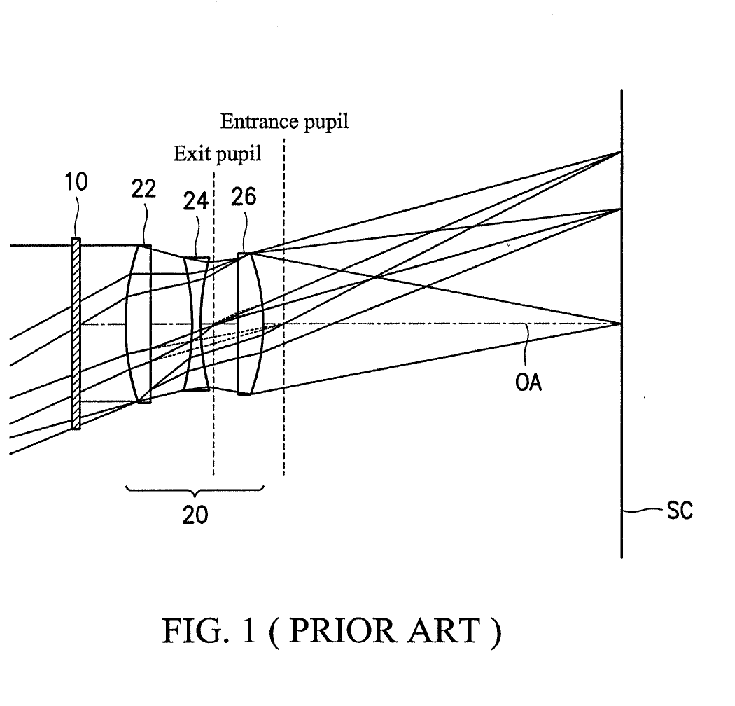

FIG. 2A is a schematic view representing the relationship between the zoom ratio and the distance from projector to screen;

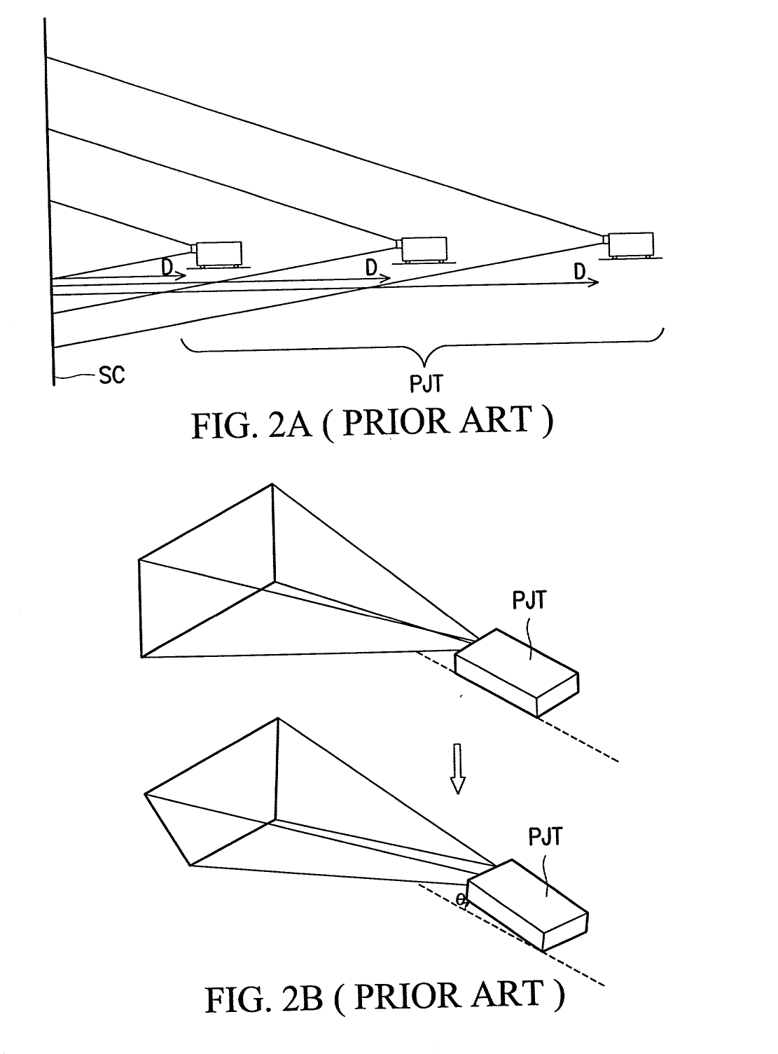

FIG. 2B is a schematic view showing the image distortion by increasing the angle of elevation of a projector;

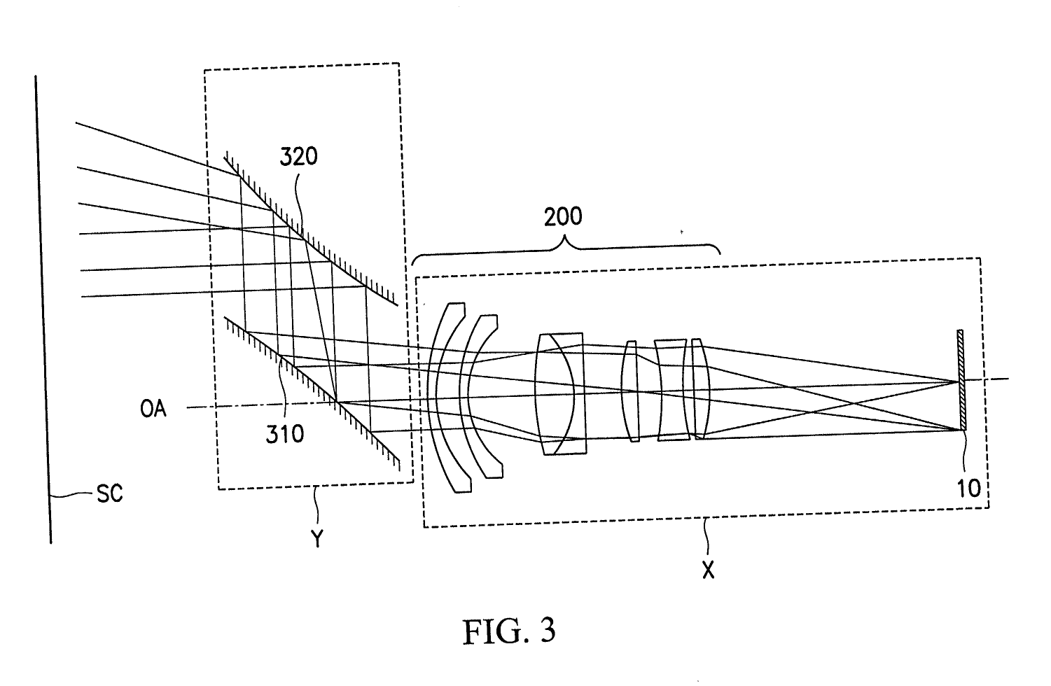

FIG. 3 schematically shows the structure of a reflecting projection unit of a projector in the first embodiment of the present invention;

FIGS. 4A and 4B are schematic views showing the projecting image shifting toward one side of the screen;

FIG. 5 schematically shows the structure of a reflecting projection unit of a projector in the second embodiment of the present invention;

FIG. 6 schematically shows a rotary second mirror in the embodiment of the invention;

### DETAILED DESCRIPTION OF THE PREFERRED EMBODIMENTS

First Embodiment

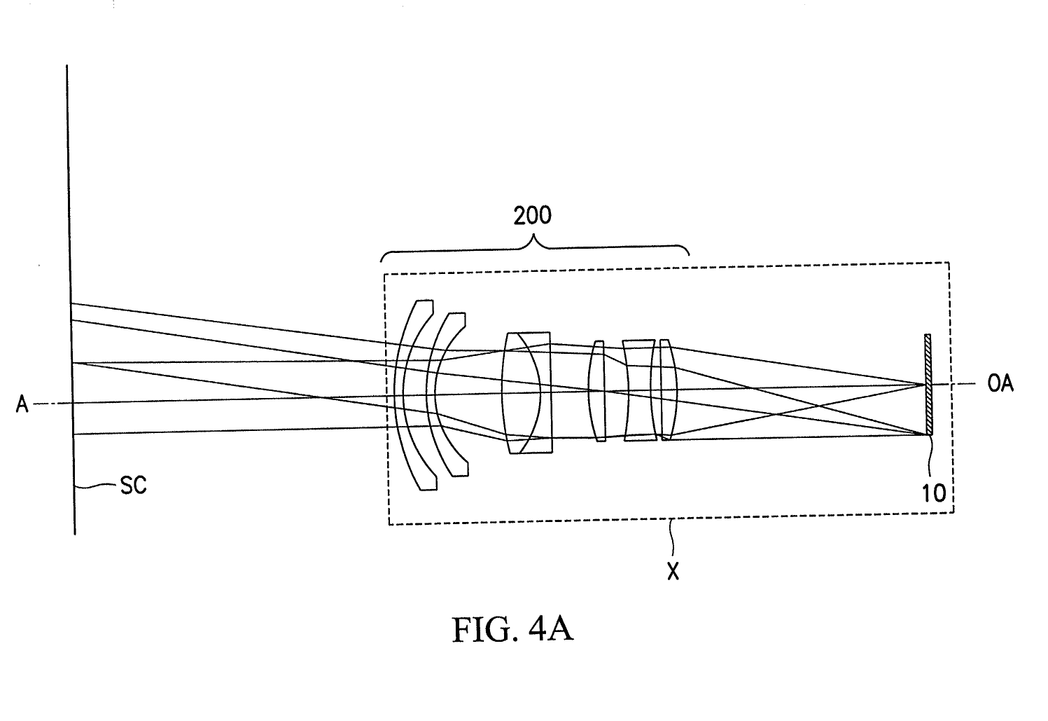

FIG. 3 is a schematic view showing the structure of a reflecting projection unit of a projector in the first embodiment of the present invention.

As shown in FIG. 3, the reflecting projection unit Y of the embodiment of the invention includes a first mirror 310 and a second mirror 320. The reflecting projection unit Y receives a projecting image from a projection system X and reflects it onto a screen. The projection system X has an image display device 10 and a projection lens 200.

The projection lens 200 can zoom in or zoom out the image from the image display device 10 and projects it to the reflecting projection unit Y. In the reflecting proj ection unit Y, the first mirror 310 receives the image from the projection system X, and reflects it to the second mirror 320 with a predetermined angle of first reflection. The second mirror 320 receives the image from the first mirror 310, and reflects it to the screen SC with another predetermined angle of second reflection.

The first reflecting surface of the first mirror 310 is a convex surface to enlarge the projecting image from the projection lens 200, and reflects it to the second mirror 320. The second reflecting surface of the second mirror 320 is a convex surface to enlarge the projecting image from the first mirror 310, and reflects it to the screen SC.

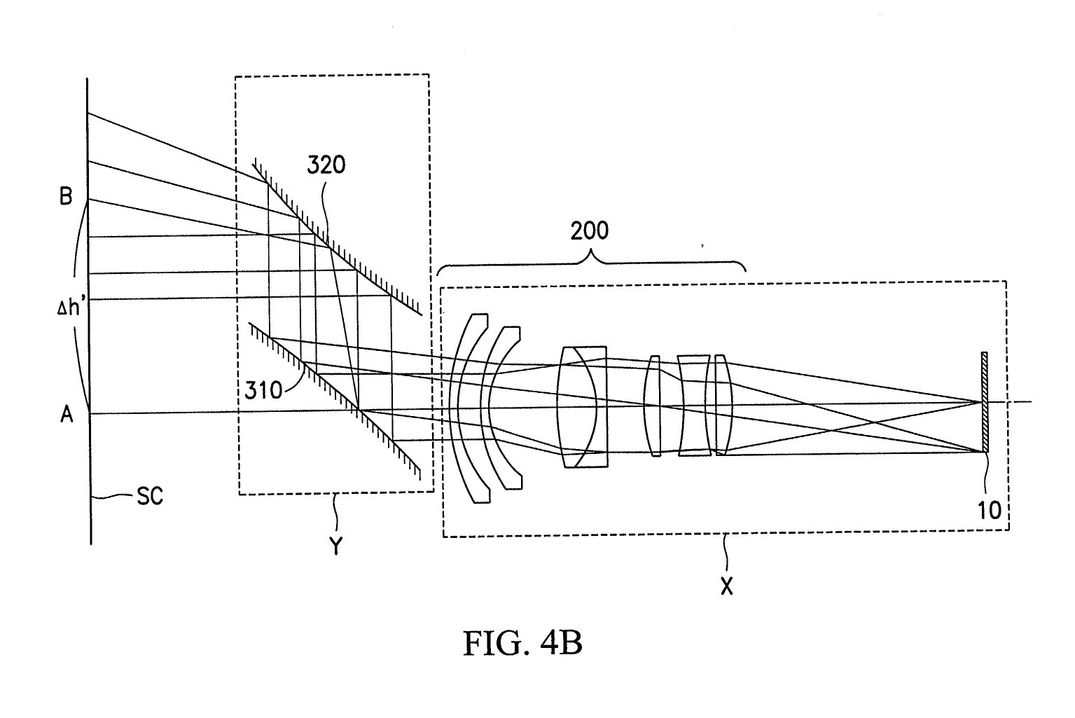

As shown in FIG. 4A, in a projector without the reflecting projection unity, the projection lens 200 receives the image light of the center portion from the image display device 10, and then projects the image to A point of the screen SC. Therefore, A point is the image center displayed on the screen SC.

As shown in FIG. 4B, in a projector with the reflecting projection unit Y, the image is projected to the screen SC by using the projection system X and the reflecting projection unit Y.

As shown in FIG. 4B, the projection lens 200 and the reflecting projection unit Y project the image light of the center portion from the image display device onto B point of the screen SC. Therefore, B point is the image center displayed on the screen SC.

In contrast with FIGS. 4A and 4B, the image center is shifted from A point to B point on the screen SC. The shifting distance between A point and B point is Δh′ which shown in FIG. 4B. Accordingly, the image offset is increased by utilizing the reflecting projection unit.

In the first embodiment of the invention, the first and second mirrors act on the projecting image and provide an enlarged image on the screen without distortion. Simultaneously, the enlarged image is shifted toward one side of the screen by the first and second mirrors of the reflecting projection unit.

Second Embodiment

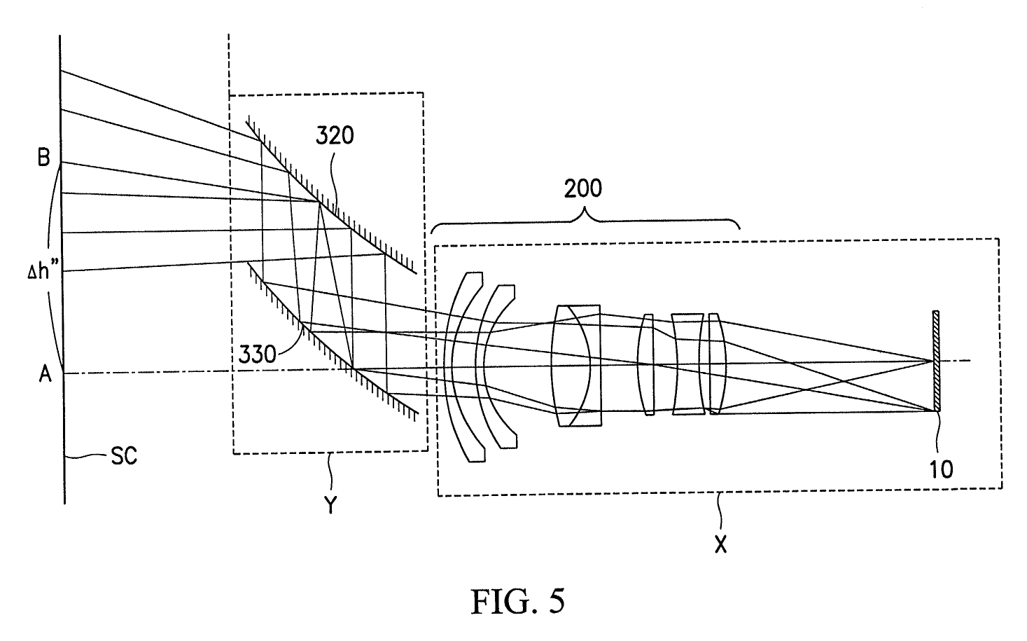

FIG. 5 is a schematic view showing the structure of a reflecting projection unit of a projector in the second embodiment of the present invention.

As shown in FIG. 5, the reflecting projection unit Y of the embodiment of the invention includes a first mirror 330 and a second mirror 320. The reflecting projection unit Y receives a projecting image from a projection system X and reflects it onto a screen. The projection system X has an image display device 10 and a projection lens 200.

The projection lens 200 can zoom in or zoom out the image from the image display device 10 and projects it to the reflecting projection unit Y. In the reflecting projection unit Y, the first mirror 330 receives the image from the projection system X, and reflects it to the second mirror 320 with a predetermined angle of first reflection. The second mirror 320 receives the image from the first mirror 330, and reflects it to the screen SC with another predetermined angle of second reflection.

The first reflecting surface of the first mirror 330 is a concave surface to minify the projecting image from the projection lens 200, and reflects it to the second mirror 320. The second reflecting surface of the second mirror 320 is a convex surface to enlarge the projecting image from the first mirror 330, and reflects it to the screen SC. In the second embodiment of the invention, the total magnification of the compound mirrors won't shrink the image.

As shown in FIG. 5, the projection system X and the reflecting projection unit Y project the image light of the center portion from the image display device onto B point of the screen SC. Therefore, B point is the image center displayed on the screen SC.

In contrast with FIGS. 4A and 5, the image center is shifted from A point to B point on the screen SC. The shifting distance between A point and B point is Δh″ which shown in FIG. 5. Accordingly, the image offset is increased by using the reflecting projection unit.

In the second embodiment of the invention, the first and second mirrors act on the projecting image and provide an enlarged image on the screen without distortion. Simultaneously, the enlarged image is shifted toward one side of the screen by the first and second mirrors 330, 320 of the reflecting projection unit.

The second embodiment of the invention has an advantage of reducing cost of the reflecting projection unit. Because the first concave mirror 330 minifies the image on the second mirror 320, the area of the second mirror 320 is reduced. Furthermore, the second embodiment reduces the cost of the second mirror.

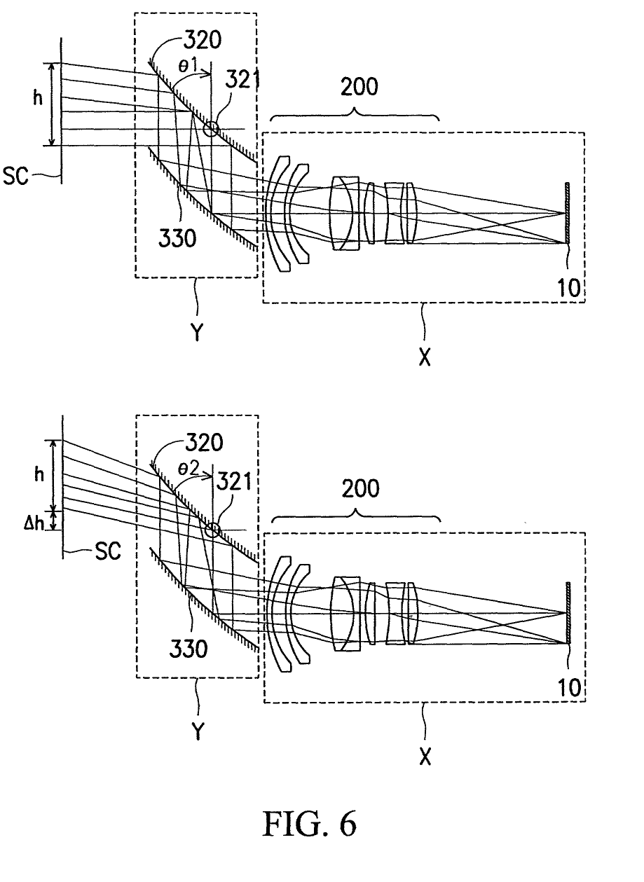

FIG. 6 schematically shows a rotary second mirror in the embodiment of the invention. As shown in FIG. 6, the reflecting projection unit Y receives a projecting image from a projection system X and reflects it onto a screen. The projection system X has an image display device 10 and a projection lens 200. The reflecting projection unit Y includes a first mirror 330 and a second mirror 320. The second mirror 320 is provided with a rotary axis 321, and then rotates around the rotary axis 321. As shown in FIG. 6, when the second mirror 320 clockwise rotates from first included angle θ1 to second included angle θ2, an image within a tolerance of distortion is projected on the screen SC. Accordingly, the clockwise rotation of the second mirror increases shifting distance Δh of the image on the screen SC.

In the embodiments of the invention, the convex mirror is provided with spherical surface or aspherical surface, and the concave mirror is provided with spherical surface or aspherical surface.

In the invention, the reflecting projection unit can be applied to any kinds of projector by attaching it to the projection lens.

While the preferred embodiment of the present invention has been described, it is to be understood that modifications will be apparent to those skilled in the art without departing from the spirit of the invention. The scope of the invention, therefore, is to be determined solely by the following claims.

What is claimed is:

1. A reflecting projection unit for a projector, comprising:
a first mirror having a first reflecting surface; and
a second mirror having a second reflecting surface and positioned opposite to the first mirror;
wherein the first reflecting surface of the first mirror receives a first projecting image from the projector according to a predetermined angle and reflects a second projecting image, and then the second mirror receives the second projecting image from the first mirror and reflects a third projecting image to a screen.

2. A reflecting projection unit for a projector as claimed in claim 1, wherein the first mirror is a first convex mirror to enlarge the first projecting image from the projector, and reflects the second projecting image to the second mirror.

3. A reflecting projection unit for a projector as claimed in claim 2, wherein the second mirror is a second convex mirror to enlarge the second projecting image from the first mirror, and reflects the third projecting image to the screen.

4. A reflecting projection unit for a projector as claimed in claim 1, wherein the second mirror is provided with a rotary axis in a predetermined position, and an offset of the projecting image on the screen is increased by rotating the second mirror around the rotary axis.

5. A reflecting projection unit for a projector as claimed in claim 2, wherein the first convex mirror is selected from the group consisting of spherical convex mirror and aspherical convex mirror.

6. A reflecting projection unit for a projector as claimed in claim 3, wherein the second convex mirror is selected from the group consisting of spherical convex mirror and aspherical convex mirror.

7. A reflecting projection unit for a projector as claimed in claim 1, wherein the first mirror is a first concave mirror to minify the first projecting image from the projector, and reflects the second projecting image to the second mirror.

8. A reflecting projection unit for a projector as claimed in claim 7, wherein the second mirror is a second convex mirror to enlarge the second projecting image from the first mirror, and reflects the third projecting image to the screen.

9. A reflecting projection unit for a projector as claimed in claim 8, wherein the second mirror is provided with a rotary axis in a predetermined position, and an offset of the projecting image on the screen is increased by rotating the second mirror around the rotary axis.

10. A reflecting projection unit for a projector as claimed in claim 7, wherein the first concave mirror is selected from the group consisting of spherical concave mirror and aspherical concave mirror.

11. A reflecting projection unit for a projector as claimed in claim 8, wherein the second convex mirror is selected from the group consisting of spherical convex mirror and aspherical convex mirror.
